(19) United States
(12) Patent Application Publication
(10) Pub. No.: US 2026/0320393 A1
(43) Pub. Date: Oct. 15, 2026

(54) DYNAMIC SEMANTIC MODEL PRUNING FOR NATURAL-LANGUAGE-QUERYING

(71) Applicant: Snowflake Inc., Menlo Park, CA (US)

(72) Inventors: Ashwin Devaraj, Menlo Park, CA (US); Danmei Xu, Santa Clara, CA (US)

(21) Appl. No.: 19/577,070

(22) Filed: Mar. 24, 2026

Related U.S. Application Data
(60) Provisional application No. 63/786,170, filed on Apr. 9, 2025.

(51) Int. Cl. G06N 3/082; G06F 16/3332

(52) U.S. Cl. CPC G06N 3/082; G06F 16/3332

(57) ABSTRACT

Systems and methods are provided for dynamically routing natural language queries to the most relevant semantic model in environments with multiple domain-specific models. Upon receiving a user query, each candidate semantic model is pruned to retain only the most relevant columns and verified queries based on similarity to the query. A multi-stage pipeline then performs embedding-based retrieval to identify top-matching models, followed by a large language model (LLM) that ranks and selects the optimal semantic model for execution. This approach reduces latency, preserves context within token limits, and improves the accuracy of query-to-model matching. The invention enables seamless, conversational data interactions across structured and unstructured sources, improving usability, performance, and scalability in enterprise analytics systems.

### CROSS-REFERENCE TO RELATED APPLICATIONS

This application claims priority to and the benefit of U.S. Provisional Patent Application No. 63/786,170, entitled “DYNAMIC SEMANTIC MODEL PRUNING FOR NATURAL-LANGUAGE-QUERYING,” filed on Apr. 9, 2025, which is incorporated herein by reference in its entirety.

### TECHNICAL FIELD

Embodiments of the disclosure relate generally to cloud data platforms and, more specifically, to semantic model pruning for natural language querying.

### BACKGROUND

Data platforms are widely used for data storage and data access in computing and communication contexts. With respect to architecture, a data platform could be an on-premises data platform, a network-based data platform (e.g., a cloud-based data platform), a combination of the two, and/or include another type of architecture. With respect to types of data processing, a data platform could implement online transactional processing (OLTP), online analytical processing (OLAP), a combination of the two, and/or another type of data processing. Moreover, a data platform could be or include a relational database management system (RDBMS) and/or one or more other types of database management systems.

In a typical implementation, a data platform includes one or more databases that are maintained on behalf of a customer account. Indeed, the data platform may include one or more databases that are respectively maintained in association with any number of customer accounts, as well as one or more databases associated with a system account (e.g., an administrative account) of the data platform, one or more other databases used for administrative purposes, and/or one or more other databases that are maintained in association with one or more other organizations and/or for any other purposes. A data platform may also store metadata in association with the data platform in general and in association with, as examples, particular databases and/or particular customer accounts as well.

Users and/or executing processes that are associated with a given customer account may, via one or more types of clients, be able to cause data to be ingested into the database, and may also be able to manipulate the data, add additional data, remove data, run queries against the data, generate views of the data, and so forth.

When certain information is to be extracted from a database, a query statement may be executed against the database data. A data platform may process the query and return certain data according to one or more query predicates that indicate what information should be returned by the query. The data platform extracts specific data from the database and formats that data into a readable form.

### BRIEF DESCRIPTION OF THE DRAWINGS

The present disclosure will be apparent from the following more particular description of examples of embodiments of the technology, as illustrated in the accompanying drawings. The drawings are not necessarily to scale, emphasis instead being placed upon illustrating embodiments of the present disclosure. In the drawings, like numerals may describe similar components in different views. Like numerals having different letter suffixes may represent different instances of similar components. Various ones of the appended drawings merely illustrate example embodiments of the present disclosure and should not be considered as limiting its scope.

FIG. 1 illustrates an example computing environment that includes a cloud data platform, according to some examples.

FIG. 2 is a block diagram illustrating components of a compute service manager of the cloud data platform, according to some examples.

FIG. 3 illustrates an example method for processing a natural language query, according to some examples.

FIG. 4 is an architectural diagram illustrating an example selection of a semantic model in response to a natural language query, according to some examples.

FIG. 5 illustrates an example of training and use of a machine-learning program, according to some examples.

FIG. 6 illustrates an example machine-learning pipeline, according to some examples.

FIG. 7 illustrates a diagrammatic representation of a machine in the form of a computer system within which a set of instructions may be executed for causing the machine to perform any one or more of the methodologies discussed herein, in accordance with some examples of the present disclosure.

### DETAILED DESCRIPTION

Reference will now be made in detail to specific example embodiments for carrying out the inventive subject matter. Examples of these specific embodiments are illustrated in the accompanying drawings, and specific details are set forth in the following description to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure. The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail. For the purposes of this description, the phrase “cloud data platform” may be referred to as and used interchangeably with the phrases “a network-based database system,” “a database system,” or merely “a platform.”

In the present disclosure, physical units of data that are stored in a data platform—and that make up the content of, e.g., database tables in user accounts—are referred to as micro-partitions. In different implementations, a data platform may store metadata in micro-partitions as well. The term “micro-partitions” is distinguished in this disclosure from the term “files,” which, as used herein, refers to data units such as image files (e.g., Joint Photographic Experts Group (JPEG) files, Portable Network Graphics (PNG) files, etc.), video files (e.g., Moving Picture Experts Group (MPEG) files, MPEG-4 (MP4) files, Advanced Video Coding High Definition (AVCHD) files, etc.), Portable Document Format (PDF) files, documents that are formatted to be compatible with one or more word-processing applications, documents that are formatted to be compatible with one or more spreadsheet applications, and/or the like. If stored internal to the data platform, a given file is referred to herein as an “internal file” and may be stored in (or at, on, etc.) what is referred to herein as an “internal storage location.” If stored external to the data platform, a given file is referred to herein as an “external file” and is referred to as being stored in (or at, on, etc.) what is referred to herein as an “external storage location.” These terms are further discussed below.

Computer-readable files come in several varieties, including unstructured files, semi-structured files, and structured files. These terms may mean different things to different people. As used herein, examples of unstructured files include image files, video files, PDFs, audio files, and the like; examples of semi-structured files include JavaScript Object Notation (JSON) files, eXtensible Markup Language (XML) files, and the like; and examples of structured files include Variant Call Format (VCF) files, Keithley Data File (KDF) files, Hierarchical Data Format version 5 (HDF5) files, and the like. As known to those of skill in the relevant arts, VCF files are often used in the bioinformatics field for storing, e.g., gene-sequence variations, KDF files are often used in the semiconductor industry for storing, e.g., semiconductor-testing data, and HDF5 files are often used in industries such as the aeronautics industry, in that case for storing data such as aircraft-emissions data. Numerous other example unstructured-file types, semi-structured-file types, and structured-file types, as well as example uses thereof, could certainly be listed here as well and will be familiar to those of skill in the relevant arts. Different people of skill in the relevant arts may classify types of files differently among these categories and may use one or more different categories instead of or in addition to one or more of these.

Data platforms are widely used for data storage and data access in computing and communication contexts. Concerning architecture, a data platform could be an on-premises data platform, a network-based data platform (e.g., a cloud-based data platform), a combination of the two, and/or include another type of architecture. Concerning the type of data processing, a data platform could implement online analytical processing (OLAP), online transactional processing (OLTP), a combination of the two, and/or another type of data processing. Moreover, a data platform could be or include a relational database management system (RDBMS) and/or one or more other types of database management systems.

In a typical implementation, a data platform includes one or more databases that are maintained on behalf of a user account. The data platform may include one or more databases that are respectively maintained in association with any number of user accounts (e.g., accounts of one or more data providers or other types of users), as well as one or more databases associated with a system account (e.g., an administrative account) of the data platform, one or more other databases used for administrative purposes, and/or one or more other databases that are maintained in association with one or more other organizations and/or for any other purposes. A data platform may also store metadata (e.g., account object metadata) in association with the data platform in general and in association with, for example, particular databases and/or particular user accounts as well. Users and/or executing processes that are associated with a given user account may, via one or more types of clients, be able to cause data to be ingested into the database, and may also be able to manipulate the data, add additional data, remove data, run queries against the data, generate views of the data, and so forth.

In an implementation of a data platform, a given database (e.g., a database maintained for a user account) may reside as an object within, e.g., a user account, which may also include one or more other objects (e.g., users, roles, privileges, and/or the like). Furthermore, a given object such as a database may itself contain one or more objects such as schemas, tables, materialized views, and/or the like. A given table may be organized as a collection of records (e.g., rows) so that each includes a plurality of attributes (e.g., columns). In some implementations, database data is physically stored across multiple storage units, which may be referred to as files, blocks, partitions, micro-partitions, and/or by one or more other names. In many cases, a database on a data platform serves as a backend for one or more applications that are executing on one or more application servers.

A data platform (e.g., database system) can support data storage for one or more different organizations (e.g., customer organizations, which can be individual companies or business entities), where each individual organization can have one or more accounts (e.g., customer accounts) associated with the individual organizations, and each account can have one or more users (e.g., unique usernames or logins with associated authentication information). Additionally, an individual account can have one or more users that are designated as an administrator for the individual account. An individual account of an organization can be associated with a specific cloud platform (e.g., cloud-storage platform, such as such as AMAZON WEB SERVICES™ (AWS™), MICROSOFT® AZURE®, GOOGLE CLOUD PLATFORM™), one or more servers or data centers servicing a specific region (e.g., geographic regions such as North America, South America, Europe, Middles East, Asia, the Pacific, etc.), a specific version of a data platform, or a combination thereof. A user of an individual account can be unique to the account. Additionally, a data platform can use an organization data object to link accounts associated with (e.g., owned by) an organization, which can facilitate management of objects associated with the organization, account management, billing, replication, failover/failback, data sharing within the organization, and the like.

Traditional data analytics systems often rely on rigid, single-model architectures that are tightly coupled to a specific domain or dataset. These systems typically require users to manually select the appropriate data model or write highly structured queries tailored to a specific schema. This introduces friction for non-technical users and limits the system’s ability to generalize across use cases. When multiple semantic models exist — such as one for sales, another for support, and another for finance — traditional systems are not equipped to intelligently determine which model should handle a given user query. Instead, they depend on manual routing or siloed applications, which results in fragmented workflows and lost context across tools.

Moreover, traditional systems struggle to keep pace with the growing complexity of enterprise data environments, where natural language interfaces and conversational analytics are becoming the norm. Users increasingly expect to ask complex, multi-layered questions in plain language — not only about structured tables but also about unstructured text sources like support tickets or meeting transcripts. In most cases, these systems lack the ability to interpret intent, disambiguate overlapping concepts, or apply rich business logic embedded in semantic models. As a result, answers may be inaccurate, overly simplistic, or require substantial rework by data teams.

Finally, traditional systems face technical limitations when scaling to environments with numerous semantic models or large, complex schemas. Embedding all semantic knowledge into a single context — for example, through a large prompt to an LLM — often exceeds token limits, slows performance, and increases costs. Without efficient mechanisms for understanding which data is relevant and why, these systems either overload the model with irrelevant information or omit critical context, degrading both accuracy and speed. These limitations create barriers to broader adoption of AI-powered analytics, especially in enterprises managing data across many departments and use cases.

Aspects of the present disclosure address the foregoing issues, among others, with a data platform, systems, methods, and devices that dynamically route natural language queries to the most relevant semantic model among a set of candidate models, enabling accurate and efficient analysis across diverse domains without requiring manual intervention. By incorporating semantic model pruning, retrieval, and ranking techniques, some examples of the disclosed multi-model system intelligently narrow down the set of available models and selects the one best suited to interpret and respond to a given query.

In some examples, the system leverages a multi-stage pipeline that begins by pruning each semantic model to its most relevant columns and verified queries in the context of the user's question. This condensed representation minimizes noise and ensures that downstream processes operate only on contextually relevant information. An embedding-based retrieval mechanism is then used to identify the most semantically similar models, followed by a large language model that performs a lightweight reasoning step to finalize model selection. This layered approach addresses the scalability challenges that plague traditional systems, preserving speed and accuracy even as the number of models and the size of each model grow.

Unlike traditional systems that force users to select a model or struggle to interpret queries spanning multiple domains, some examples of the multi-model system introduce a context-aware and adaptive framework that performs intelligent model selection at runtime. The system empowers users to interact conversationally with enterprise data through a unified interface, while abstracting away the complexity of data structure, model boundaries, and query translation. Furthermore, by ensuring model selection occurs entirely within the governed environment of the data platform, the system upholds security, access control, and auditing requirements — enabling enterprise-grade performance without sacrificing compliance or control.

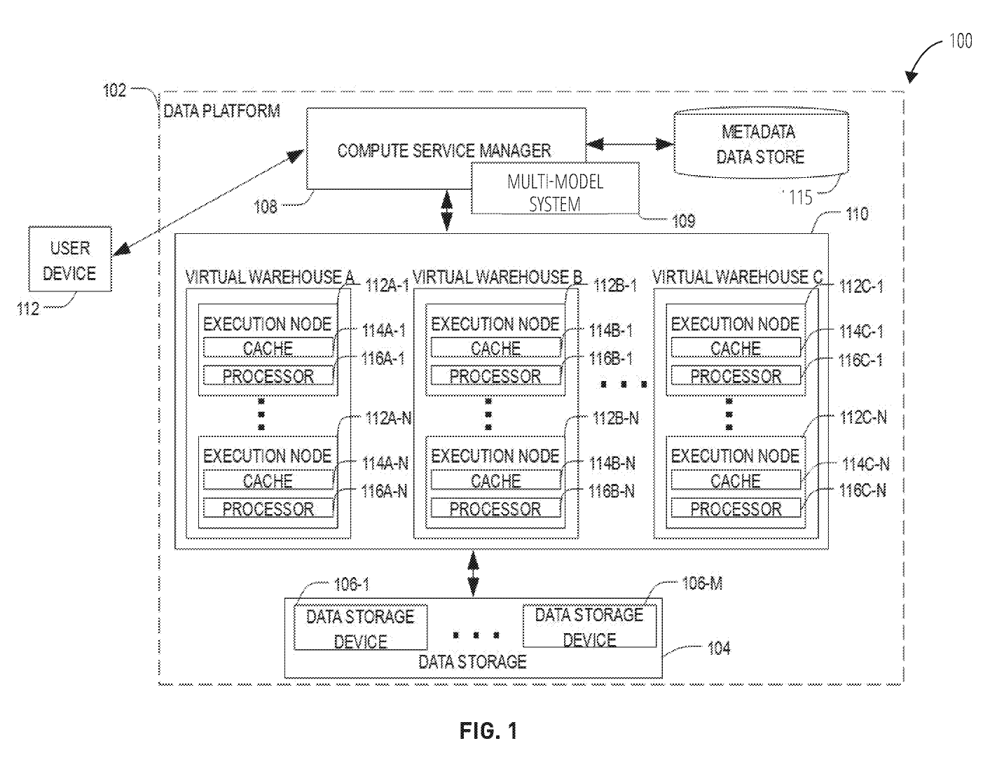

FIG. 1 illustrates an example computing environment 100 that includes a cloud data platform 102, in accordance with some embodiments of the present disclosure. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment to facilitate additional functionality that is not specifically described herein.

As shown, the cloud data platform 102 comprises a three-tier architecture: a compute service manager 108 coupled to a metadata data store 115, an execution platform 110, and data storage 104. The cloud data platform 102 hosts and provides data access, management, reporting, and analysis services to multiple client accounts. Administrative users can create and manage identities (e.g., users, roles, and groups) and use permissions to allow or deny access to the identities to resources and services. The cloud data platform 102 is used for reporting and analysis of integrated data from one or more disparate sources including storage devices within the data storage 104. The data storage 104 comprises a plurality of computing machines and provides on-demand computer system resources such as data storage and computing power to the cloud data platform 102.

The compute service manager 108 includes multiple services that coordinate and manage operations of the cloud data platform 102. For example, the compute service manager 108 is responsible for performing query optimization and compilation as well as managing clusters of compute nodes that perform query processing (also referred to as “virtual warehouses”). The compute service manager 108 can support any number of client accounts such as end users providing data storage and retrieval requests, system administrators managing the systems and methods described herein, and other components/devices that interact with compute service manager 108.

The compute service manager 108 is also coupled to the metadata data store 115. The metadata data store 115 stores metadata pertaining to various functions and aspects associated with the cloud data platform 102 and its users. The metadata data store 115 also includes a summary of data stored in data storage 104 as well as data available from local caches. Additionally, the metadata data store 115 includes information regarding how data is organized in the data storage 104 and the local caches.

As shown, the compute service manager 108 includes a multi-model system 109 that is responsible for intelligently selecting and routing natural language queries to relevant semantic model among a set of candidates, using a combination of pruning, retrieval, and large language model-based reasoning. Further details of the operation of the multi-model system 109 are discussed below.

The compute service manager 108 is also in communication with a user device 112. The user device 112 corresponds to a user of one of the multiple client accounts supported by the cloud data platform 102. In some implementations, the compute service manager 108 does not receive any direct communications from the user device 112 and only receives communications concerning jobs from a queue within the cloud data platform 102.

The compute service manager 108 is also coupled to the metadata data store 115. The metadata data store 115 stores metadata pertaining to various functions and aspects associated with the cloud data platform 102 and its users. The metadata data store 115 also includes a summary of data stored in data storage 104 as well as data available from local caches. Additionally, the metadata data store 115 includes information regarding how data is organized in the data storage 104 and the local caches.

The compute service manager 108 is further coupled to the execution platform 110, which includes multiple virtual warehouses (computing clusters) that execute various data storage and data retrieval tasks. As an example, a set of processes on a compute node executes at least a portion of a query plan compiled by the compute service manager 108. As shown, the execution platform 110 includes virtual warehouse A, virtual warehouse B, and virtual warehouse C. Each virtual warehouse includes multiple execution nodes that each includes a data cache and a processor. For example, as shown, virtual warehouse A includes execution nodes 112A-1 to 112A-N; execution node 112A-1 includes a cache 114A-1 and a processor 116A-1; and execution node 112A-N includes a cache 114A-N and a processor 116A-N. Similarly, in this example, virtual warehouse B includes execution nodes 112B-1 to 112B-N; execution node 112B-1 includes a cache 114B-1 and a processor 116B-1; and execution node 112B-N includes a cache 114B-N and a processor 116B-N. Additionally, virtual warehouse C includes execution nodes 112C-1 to 112C-N; execution node 112C-1 includes a cache 114C-1 and a processor 116C-1; and execution node 112C-N includes a cache 114C-N and a processor 116C-N.

Each execution node of the execution platform 110 is assigned to processing one or more data storage and/or data retrieval tasks. Hence, the virtual warehouses can execute multiple tasks in parallel utilizing the multiple execution nodes. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

In some examples, the execution nodes of the execution platform 110 are stateless with respect to the data the execution nodes are caching. That is, the execution nodes do not store or otherwise maintain state information about the execution node or the data being cached by a particular execution node, in these examples. Thus, in the event of an execution node failure, the failed node can be transparently replaced by another node. Since there is no state information associated with the failed execution node, the new (replacement) execution node can easily replace the failed node without concern for recreating a particular state.

The execution platform 110 may include any number of virtual warehouses. Additionally, the number of virtual warehouses in the execution platform 110 is dynamic, such that new virtual warehouses are created when additional processing and/or caching resources are needed. Similarly, existing virtual warehouses may be deleted when the resources associated with the virtual warehouse are no longer necessary.

Although each virtual warehouse shown in FIG. 1 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary. Additionally, although the execution nodes shown in the example of FIG. 1 each include a single data cache and a single processor, in other examples, execution nodes can contain any number of processors and any number of caches. Also, the caches may vary in size among the different execution nodes.

In some examples, the virtual warehouses of the execution platform 110 operate on the same data, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

Although virtual warehouses A, B, and C are illustrated with an association with the same execution platform 110, the virtual warehouses may be implemented using multiple computing systems at multiple geographic locations. For example, virtual warehouse A can be implemented by a computing system at a first geographic location, while virtual warehouses B and C are implemented by another computing system at a second geographic location. In some examples, these different computing systems are cloud-based computing systems maintained by one or more different entities.

The execution platform 110 is coupled to data storage 104. The data storage 104 comprises multiple data storage devices 106-1 to 106-M. In some embodiments, the data storage devices 106-1 to 106-M are cloud-based storage devices located in one or more geographic locations. For example, the data storage devices 106-1 to 106-M may be part of a public cloud infrastructure or a private cloud infrastructure. The data storage devices 106-1 to 106-M may be hard disk drives (HDDs), solid state drives (SSDs), storage clusters, Amazon S3^{TM} storage systems or any other data storage technology. Additionally, the data storage 104 may include distributed file systems (e.g., Hadoop Distributed File Systems (HDFS)), object storage systems, and the like. In some examples, the storage devices 106-1 to 106-M are managed and provided by a third-party data storage platform (e.g., AWS^{®}, Microsoft Azure Blob Storage^{®}, or Google Cloud Storage^{®}).

Each virtual warehouse can access any of the data storage devices 106-1 to 106-M shown in FIG. 1. Thus, the virtual warehouses are not necessarily assigned to a specific data storage device 106-1 to 106-M and, instead, can access data from any of the data storage devices 106-1 to 106-M within the data storage 104. Similarly, each of the execution nodes shown in FIG. 1 can access data from any of the data storage devices 106-1 to 106-M. In some examples, a particular virtual warehouse or a particular execution node may be temporarily assigned to a specific data storage device, but the virtual warehouse or execution node may later access data from any other data storage device.

In some examples, communication links between elements of the computing environment are implemented via one or more data communication networks. These data communication networks may utilize any communication protocol and any type of communication medium. In some examples, the data communication networks are a combination of two or more data communication networks (or sub-networks) coupled to one another.

As shown in FIG. 1, the data storage devices 106-1 to 106-M are decoupled from the computing resources associated with the execution platform 110. This architecture supports dynamic changes to the cloud data platform 102 based on the changing data storage/retrieval needs as well as the changing needs of the users and systems. The support of dynamic changes allows the cloud data platform 102 to scale quickly in response to changing demands on the systems and components within the cloud data platform 102. The decoupling of the computing resources from the data storage devices supports the storage of large amounts of data without requiring a corresponding large amount of computing resources. Similarly, this decoupling of resources supports a significant increase in the computing resources utilized at a particular time without requiring a corresponding increase in the available data storage resources.

During typical operation, the cloud data platform 102 processes multiple jobs determined by the compute service manager 108. These jobs are scheduled and managed by the compute service manager 108 to determine when and how to execute the job. For example, the compute service manager 108 may divide the job into multiple discrete tasks and may determine what data is needed to execute each of the multiple discrete tasks. The compute service manager 108 may assign each of the multiple discrete tasks to one or more execution nodes of the execution platform 110 to process the task. The compute service manager 108 may determine what data is needed to process a task and further determine which nodes within the execution platform 110 are best suited to process the task. Some nodes may have already cached the data needed to process the task and, therefore, be a good candidate for processing the task. Metadata stored in the metadata data store 115 assists the compute service manager 108 in determining which nodes in the execution platform 110 have already cached at least a portion of the data needed to process the task. One or more nodes in the execution platform 110 process the task using data cached by the nodes and, if necessary, data retrieved from the data storage 104.

The compute service manager 108, metadata data store 115, execution platform 110, and data storage 104 are shown in FIG. 1 as individual discrete components. However, each of the compute service manager 108, metadata data store 115, execution platform 110, and data storage 104 may be implemented as a distributed system (e.g., distributed across multiple systems/platforms at multiple geographic locations). Additionally, each of the compute service manager 108, metadata data store 115, execution platform 110, and data storage 104 can be scaled up or down (independently of one another) depending on changes to the requests received and the changing needs of the cloud data platform 102. Thus, in the described embodiments, the cloud data platform 102 is dynamic and supports regular changes to meet the current data processing needs.

As shown in FIG. 1, the computing environment separates the execution platform 110 from the data storage 104. In this arrangement, the processing resources and cache resources in the execution platform 110 operate independently of the data storage devices 106-1 to 106-M in the data storage 104. Thus, the computing resources and cache resources are not restricted to specific data storage devices 106-1 to 106-M. Instead, all computing resources and all cache resources may retrieve data from, and store data to, any of the data storage resources in the data storage 104.

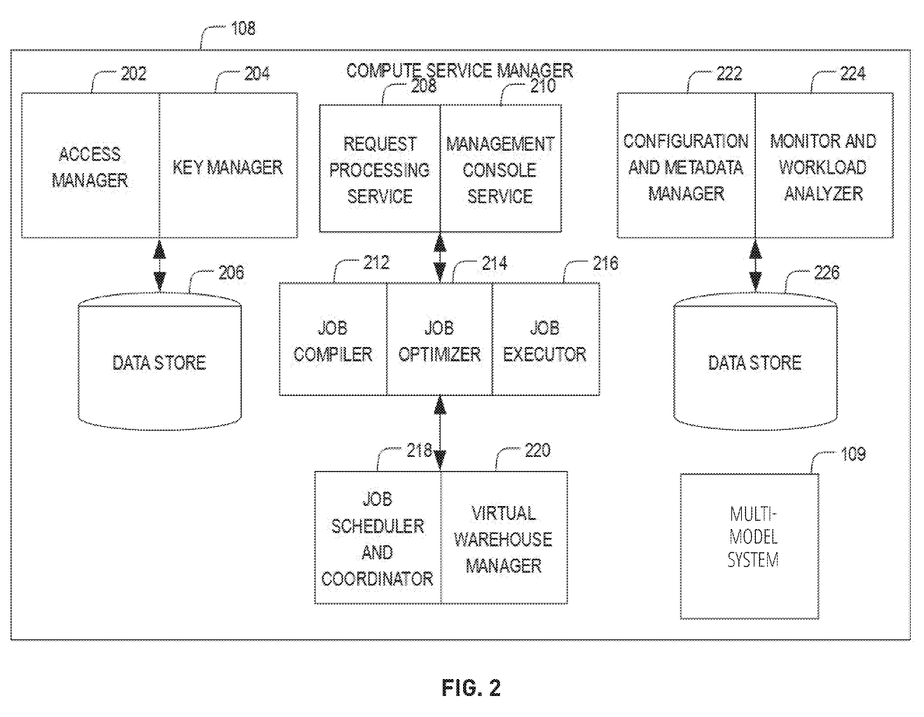

FIG. 2 is a block diagram illustrating components of the compute service manager 108, in accordance with some embodiments of the present disclosure. As shown in FIG. 2, the compute service manager 108 includes an access manager 202 and a key manager 204 coupled to a data store 206 that stores access information. Access manager 202 handles authentication and authorization tasks for the systems described herein. Key manager 204 manages storage and authentication of keys used during authentication and authorization tasks. For example, access manager 202 and key manager 204 manage the keys used to access data stored in remote storage devices (e.g., data storage devices in data storage 104).

A request processing service 208 manages received data storage requests and data retrieval requests (e.g., jobs to be performed on database data). For example, the request processing service 208 may determine the data necessary to process a received query (e.g., a data storage request or data retrieval request). The data may be stored in a cache within the execution platform 110 or in a data storage device in data storage 104.

A management console service 210 supports access to various systems and processes by administrators and other system managers. Additionally, the management console service 210 may receive a request to execute a job and monitor the workload on the system.

The compute service manager 108 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. The job optimizer 214 also handles various data pruning operations and other data optimization techniques to improve the speed and efficiency of executing the job. The job executor 216 executes the execution code for jobs received from a queue or determined by the compute service manager 108.

A job scheduler and coordinator 218 sends received jobs to the appropriate services or systems for compilation, optimization, and dispatch to the execution platform 110. For example, jobs may be prioritized and processed in that prioritized order. In some examples, the job scheduler and coordinator 218 identifies or assigns particular nodes in the execution platform 110 to process particular tasks.

A virtual warehouse manager 220 manages the operation of multiple virtual warehouses implemented in the execution platform 110. As discussed below, each virtual warehouse includes multiple execution nodes that each include a cache and a processor.

Additionally, the compute service manager 108 includes a configuration and metadata manager 222, which manages the information related to the data stored in the remote data storage devices and in the local caches (e.g., the caches in execution platform 110). The configuration and metadata manager 222 uses the metadata to determine which storage units need to be accessed to retrieve data for processing a particular task or job. A monitor and workload analyzer 224 oversees processes performed by the compute service manager 108 and manages the distribution of tasks (e.g., workload) across the virtual warehouses and execution nodes in the execution platform 110. The monitor and workload analyzer 224 also redistributes tasks, as needed, based on changing workloads throughout the cloud data platform 102 and may further redistribute tasks based on a user (e.g., “external”) query workload that may also be processed by the execution platform 110. The configuration and metadata manager 222 and the monitor and workload analyzer 224 are coupled to a data store 226. Data store 226 in FIG. 2 represents any data repository or device within the cloud data platform 102. For example, data store 226 may represent caches in execution platform 110, storage devices in data storage 104, the metadata data store 115, or any other storage device or system.

In addition, as mentioned above, the compute service manager 108 includes a multi-model system 109 that is responsible for determining, at runtime, the most relevant semantic model to handle a user query by leveraging model pruning, semantic retrieval, and LLM-based selection techniques. Further details regarding the functionality of the multi-model system 109 are discussed below.

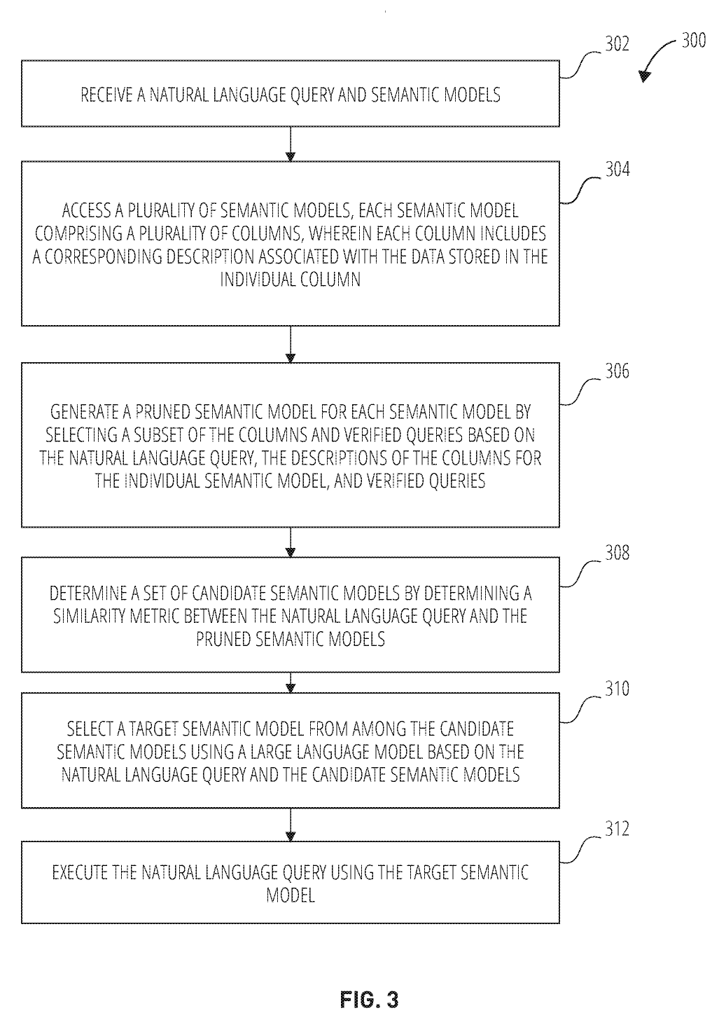

FIG. 3 illustrates an example method 300 for processing a natural language query by selecting and utilizing a target semantic model from among multiple semantic models based on relevance to the query, according to some examples. Although the example method 300 depicts a particular sequence of operations, the sequence may be altered without departing from the scope of the present disclosure. For example, some of the operations depicted may be performed in parallel or in a different sequence that does not materially affect the function of the method 300. In other examples, different components of an example device or system that implements the method 300 may perform functions at substantially the same time or in a specific sequence.

At block 302, the multi-model system receives a natural language query and one or more semantic models. The query can be expressed in free-form text and/or may originate from one or more user interfaces or integrated platforms, including but not limited to: web-based dashboards, chat-based assistants, voice-driven interfaces (converted to text), or programmatic APIs embedded within business applications. The system is configured to handle a broad range of user intents, including requests for factual data, comparisons across time or categories, aggregations, filtering, and trend analyses.

Although examples describe a natural language query, it is appreciated that the user query can include an interactive request via a communication interface of a data platform. For example, the interactive request can comprise a question requesting a response from the communication interface.

This interaction can occur in real-time, where the user expects a quick, interactive response from the platform. The interface can capture the user's input and identify whether the input includes simple text to more complex requests.

The data platform initiates a chat message comprising a user interface configured to receive prompts from a first user. The data platform initiates display of the interactive component through which users can input their queries or commands, allowing the system to interact with the users effectively.

In some cases, the data platform assesses prompts to identify a query. In some embodiments, the data platform also categorizes the prompts. This categorization process helps the data platform to determine whether the prompt requires data retrieval from a third-party dataset or if the prompt can be responded to by an LLM directly.

For example, the data platform classifies the prompts into three distinct categories. The first category can include a conversational prompt that do not require any search or retrieval from an indexed database. For instance, greetings or simple expressions of courtesy fall into this category. When a prompt is categorized as such a pleasantry, the data platform can immediately request an LLM to provide a quick and fast response, ensuring a seamless conversational flow without unnecessary delays.

Prompt categories can include a dataset-specific question, where these prompts specifically ask for information that needs to be retrieved from a database. For example, if a user queries specific data points or trends within a dataset, the system recognizes the need for database retrieval to generate an accurate response. In this case, the system initiates the necessary search processes, as further described herein, to fetch the relevant data from the indexed tables or databases.

Prompt categories can include questions on metadata, where this category includes queries about the dataset's metadata or general knowledge about the data. For example, if a user asks about the type of data available or how to interact with the dataset, the system categorizes such prompts as a metadata question. This type of prompt involves providing information about the dataset's structure, available fields, or how to perform specific queries, and as such, initiates the necessary search processes, as further described herein.

To efficiently handle this categorization, the data platform can apply a separate machine learning model, such as a smaller LLM, which specializes in classifying prompts into these categories. By leveraging this categorization step, the data platform can quickly determine the appropriate action for each prompt. If a prompt is classified as a pleasantry, the system can bypass the search index and directly generate a response using the LLM. For dataset-specific questions and metadata inquiries, the system proceeds with the document or text retrieval processes as described herein, ensuring that users receive accurate and relevant information based on their queries.

At block 304, the multi-model system accesses a plurality of semantic models. In some cases, one or more semantic models can include a plurality of columns and/or verified queries. One or more columns can include a corresponding description associated with the data stored in the individual column.

Each semantic model may be associated with a distinct data domain (e.g., marketing, finance, support, sales, operations), and/or may store data in various formats, including but not limited to: structured text files (e.g., YAML, JSON), database-native metadata tables, or objects within a data cataloging platform. The system may access these semantic models from a centralized repository, such as a metadata layer maintained within a cloud data platform, or from distributed sources specified at runtime.

In some implementations, each semantic model includes a plurality of columns, which correspond to data fields or attributes present in one or more underlying database tables or views. Each column is associated with a description. In some cases, these descriptions are expressed in natural language that explains the meaning, purpose, or usage of the column within the context of the data domain. For example, a column named churn_rate may have an associated description such as “Percentage of customers who canceled their subscriptions within a given time period.”

These column descriptions serve as semantic anchors that allow the system to interpret and match user queries to the appropriate columns, even when there is no direct name match. For instance, a user query referring to “customer loss” could semantically align with a churn_rate column based on the natural language description, despite having different vocabulary. The presence of these descriptions enables the system to function effectively in natural language-driven environments, where users may express concepts in a variety of ways.

In some implementations, semantic models may additionally include a set of verified queries, which are example natural language questions known to correspond accurately to the underlying schema. Each verified query may be associated with a validated SQL translation or a canonical intent.

These verified queries serve as additional semantic anchors, enabling the system to compare an incoming query against known query examples. The system may compute a similarity metric between the natural language query and each verified query within a semantic model, and select a subset—such as the top five most relevant verified queries—for use in generating the pruned semantic model or scoring model relevance.

In some cases, the semantic column text representations that are embedded into the semantic models can include additional information such as semantic model name, top-level description of the semantic model, table name, table description. The pruning features described herein can also apply this additional information.

In some embodiments, the system may access a predefined list of semantic models provided by the user along with the query (e.g., such as via API). In other embodiments, the system itself may determine which semantic models to access based on metadata, domain relevance, user profile, past usage patterns, or other criteria.

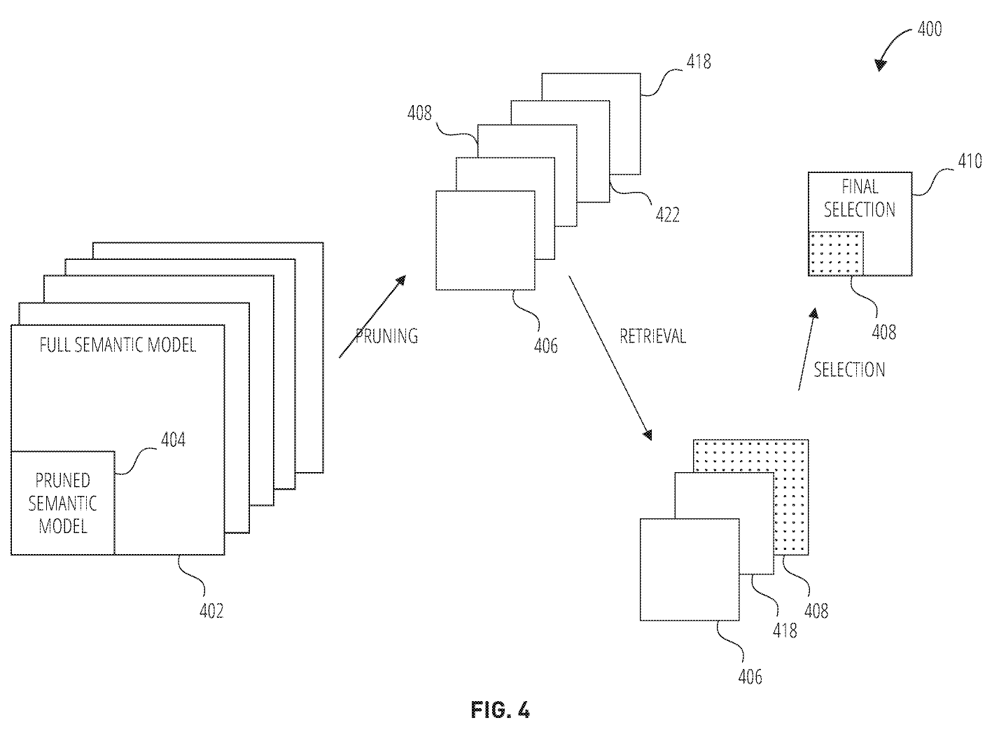

FIG. 4 is an architectural diagram 400 illustrating an example selection of a semantic model in response to a natural language query, according to some examples. The architecture in FIG. 4 illustrates a full semantic model 402, which includes a collection of available semantic models that may be considered in response to a natural language query. The system obtains this list from one or more sources, such as from the user providing the query.

In some embodiments, the semantic model list 402 may be user-provided, for instance as part of the incoming query payload. This allows client applications to identify the models that the multi-model system should consider for a given query. In such cases, the user or calling application passes a list of model identifiers, names, file paths, or references, which the system resolves and loads into memory for processing.

Returning to FIG. 3, at block 306, the multi-model system generates a pruned semantic model for each semantic model by selecting a subset of the columns and/or verified queries based on the natural language query and the descriptions of the columns for the individual semantic model. In some cases, the multi-model system generates a pruned semantic model based on semantic similarity between the natural language query and the column descriptions of the individual semantic model.

Each semantic model accessed in block 304 may include a number of columns, each representing a distinct attribute, metric, or dimension of the underlying dataset. For example, a semantic model for customer analytics may contain columns such as customer_id, churn_rate, subscription_type, signup_date, and so on. Each column can be associated with a natural language description, which provides a human-readable explanation of the data stored in that column (e.g., “Percentage of customers who canceled their subscriptions in a given time period”).

At this stage, the multi-model system evaluates the relevance of each column in a given semantic model to the natural language query. The multi-model system can evaluate the relevance by comparing the semantic content of the query to the semantic content of each column description within the model.

To enable this comparison, the system can convert both the query and each column description into an embedding, such as a vector-based embedding, using a trained natural language embedding model. The embeddings can include numerical representations of the respective text inputs in a high-dimensional space, where the distance or angle between vectors represents semantic similarity. In some implementations, the multi-model system computes a cosine similarity between the query vector and each column description vector.

In some examples, embeddings are designed such that the angle between vectors corresponds to the semantic distance between the associated texts, with smaller angles indicating higher similarity. Cosine similarity is used to compute the angular distance between the embeddings and rank the columns accordingly.

The system then selects a subset of the columns—such as the top N columns with the highest similarity scores—as being the most relevant to the query. This selected subset forms the basis of a pruned semantic model, which is a reduced version of the original semantic model that includes only the most relevant columns. This pruning process is independently performed for each semantic model in the full list or candidate list.

In some cases, the system may also apply thresholds or caps to ensure that the number of columns selected does not exceed a predefined token or memory budget, particularly if the pruned models are to be passed to a downstream large language model (LLM) for further reasoning. The result of this process is a collection of pruned semantic models, each comprising a contextually relevant subset of columns, which greatly reduces noise and computational overhead in the subsequent stages of model retrieval and selection.

Referring again to FIG. 4, the system begins with a collection of full semantic models, full semantic model 402, which represents a complete schema associated with a particular data domain. The full semantic model may include a large number of columns, each with associated metadata such as a column name, a natural language description, a data type, and optionally a set of verified queries.

This full model is intended to capture all available fields and queryable concepts within a given dataset, making it highly comprehensive but potentially too large and noisy for efficient semantic matching during query interpretation. Accordingly, the multi-model system performs a pruning operation on the full semantic model 402 to generate a pruned semantic model 404.

The pruned semantic model 404 is a reduced and focused version of the full semantic model 402. The pruned model contains a subset of columns—those determined to be likely relevant to the received natural language query. As described previously, relevance can be established in one of several ways, such as by comparing the query against the column descriptions and selecting the top-N columns based on semantic similarity scores. The pruned model 404 thus serves as a lightweight representation that preserves the information likely useful for understanding and answering the query. This reduction in size and scope improves downstream processing efficiency, particularly for retrieval and large language model reasoning tasks.

The pruning process can be performed independently for each semantic model under consideration. As a result, the system produces a collection of pruned semantic models, such as pruned semantic models 406 and 408, each corresponding to one of the full semantic models accessed or identified during the earlier stages.

Each pruned model in this collection contains a targeted subset of its respective original columns, tailored to the specific query. This collection becomes the input for subsequent stages such as model retrieval and LLM-based selection, where one of the pruned semantic models is ultimately selected as the most suitable for executing the query.

In some embodiments, a semantic model represents a structured definition of an underlying dataset, such as a database table, view, or combination thereof. Each semantic model may correspond directly to a database or logical data source and define the columns, metrics, filters, and relationships relevant to querying that data. In this context, the semantic model acts as a metadata layer that maps natural language concepts to the schema and semantics of the underlying database.

The system performs the pruning operation independently for each semantic model under consideration. For every semantic model in the accessed or candidate set, the system selects a subset of columns—based on their semantic similarity to the natural language query—to construct a corresponding pruned semantic model. This allows the system to evaluate each model’s query relevance in isolation and generate a reduced representation tailored to the user's intent.

In some cases, the system may skip the pruning operation for a given semantic model if the model contains fewer than a predefined number of columns or verified queries. For example, if a semantic model includes only 10 or fewer columns, or five or fewer verified queries, the benefit of pruning may be negligible. In such cases, the system may retain the full semantic model for subsequent processing to avoid unnecessary computation or information loss.

Returning to FIG. 3, at block 308, the multi-model system determines a set of candidate semantic models by determining a similarity metric between the natural language query and each of the pruned semantic models. One of the purposes of at least a portion of this step is to narrow down the number of semantic models under consideration before passing them to a downstream large language model (LLM) for final selection.

In some embodiments, the system performs this retrieval step by comparing the semantic content of the query against the content of each pruned semantic model. To enable this comparison, the system generates a numerical embedding of the natural language query, as well as a numerical embedding for each pruned semantic model. The embedding for a pruned semantic model may be computed by aggregating the embeddings of the selected column descriptions, verified queries, or other elements retained during the pruning stage.

In some implementations, these embeddings represent high-dimensional vectors generated using a pretrained or fine-tuned text embedding model, such as a transformer-based sentence encoder or other neural embedding architecture. The embeddings are constructed such that semantically similar text inputs yield vector representations that are close in the embedding space.

The system may compute cosine similarity scores between the embedding of the query and the embedding of each pruned semantic model, with higher scores indicating greater relevance. For example, if a user query is “What was the churn rate after the price increase last quarter?”, the system may compute similarity scores between this query and several pruned semantic models—each representing a different domain such as sales, support, or marketing—and determine that the customer analytics model has the highest score due to its inclusion of relevant metrics and language.

The system then selects a subset of top-ranked pruned semantic models—such as the top K models with the highest similarity scores—to pass to the next processing stage. This set becomes the candidate semantic model set used for final selection via the LLM. The value of K may be predetermined or dynamically computed based on system constraints or performance tuning.

In some embodiments, the retrieval step may be skipped altogether if the total number of available or pruned semantic models is below a specified threshold. For example, if only three pruned models exist at runtime, the system may bypass retrieval and pass all three directly to the selection step. This conditional execution avoids unnecessary computation in low-volume scenarios while preserving accuracy.

Referring to FIG. 4, the system begins with a list of pruned semantic models, such as pruned semantic models 408, 406, 418, and 422. Each of these pruned semantic models has been generated through a prior pruning process (e.g., at block 306 in FIG. 3), in which the columns and/or verified queries likely relevant to a natural language query were retained.

The system performs a retrieval stage that computes a similarity metric between the natural language query and each of the pruned semantic models. This may be done by embedding the query and each pruned semantic model into a shared semantic space, and calculating cosine similarity or another relevance score.

As shown in FIG. 4, this process results in the identification of a set of candidate semantic models—in this example, models 406, 408, and 418—based on having the highest similarity scores with respect to the query. The excluded model 422 may have had a lower relevance score and thus was omitted from the candidate set.

This candidate set of pruned semantic models is then passed forward to a selection stage, where a large language model (LLM) or other model performs an evaluation to determine the best-fit semantic model for executing the query. The filtering performed in this retrieval step reduces computational burden of the LLM by passing promising candidates to the LLM.

Returning to FIG. 3, at block 310, the multi-model system selects a target semantic model from among the candidate semantic models using a large language model based on the natural language query and the candidate semantic models.

This selection is performed using a large language model (LLM) that receives the natural language query and representations of the candidate semantic models as input and outputs a ranked list or selection of the most appropriate semantic model to handle the query.

In some embodiments, the LLM is prompted with the query text and metadata extracted from the pruned semantic models, including the top-ranked column descriptions, verified queries, or model summaries.

The LLM evaluates the semantic fit between the user’s query and the structure and semantics of each candidate model. For example, if the query is "What was the churn rate after the price increase?" and the candidate models include customer analytics, sales metrics, and marketing engagement, the LLM may determine that the customer analytics model most closely aligns with the terms and intent of the query. The LLM may use natural language reasoning techniques to associate abstract or synonymous concepts (e.g., "customer loss" with "churn") and map them to the metadata included in the pruned semantic models.

In some implementations, the LLM outputs a ranked list of candidate semantic models, possibly with a confidence score or brief explanation. The system may then select the top-ranked model as the target semantic model to be used in subsequent query translation and execution. This LLM-driven selection approach provides a more nuanced and context-aware decision process than strict keyword or rule-based matching, allowing the system to resolve ambiguity, capture query intent, and maintain flexibility in heterogeneous data environments.

Referring again to FIG. 4, after the retrieval step has identified a set of candidate semantic models—such as pruned semantic models 406, 408, and 418—the system proceeds to select one of these models as the target semantic model using a large language model (LLM). In this example, pruned semantic model 408 is shown as the model that has been selected as the most relevant to the natural language query.

The selection of pruned semantic model 408 reflects the result of an LLM evaluation in which the query and representations of each candidate model—such as selected columns or verified queries—were passed to the LLM. Based on this evaluation, the LLM determined that pruned semantic model 408 most closely aligned with the user’s query intent. As a result, semantic model 408 is selected for downstream processing, including translation of the natural language query into a structured query such as SQL.

It is appreciated that although examples herein describe the selection of a single semantic model, that in other examples, multiple semantic models can be selected. Multiple semantic models can be used to respond to the query.

For example, the system may support a conversational interface that spans multiple data sources or domains, each represented by a distinct semantic model. When a user poses a natural language query, the system may retrieve and evaluate multiple relevant semantic models rather than selecting a single best match. For example, instead of narrowing to a single target model, the system may identify a top-k set of semantic models—such as the top 3 or 5—whose structures and metadata are most semantically aligned with the user’s query. This allows the system to provide a more holistic or multi-faceted response, especially in cases where the query touches on concepts represented across different datasets.

Such a multi-model response strategy can be particularly beneficial in open-ended question-answering scenarios, where the query may not map cleanly to a single business domain or dataset. By pruning the total model set to a small, high-relevance candidate pool, the system can maintain performance while still enabling downstream components—such as large language models—to reason across multiple perspectives. This approach balances precision with breadth and supports richer, more context-aware query handling.

Returning to FIG. 3, at block 312, the multi-model system executes the natural language query using the target semantic model. This step can include two operations: (1) translating the natural language query into a formal structured query language (SQL) statement using the target semantic model, and (2) executing that SQL statement against the underlying data source associated with the semantic model to retrieve a result.

In some embodiments, the system begins this process by retrieving the full semantic model corresponding to the selected pruned semantic model. Although earlier processing stages such as pruning and selection rely on a lightweight, truncated version of each semantic model for performance optimization, the full semantic model includes the complete schema definitions, column metadata, expressions, and relationships necessary to accurately construct a syntactically and semantically valid SQL query. This includes fields and business logic that may not have been retained in the pruned version but are nonetheless required for query compilation and execution.

Once the full semantic model 410 has been retrieved, the system applies a natural language-to-SQL translation engine. This engine may use a combination of rules, templates, and/or machine learning models (e.g., fine-tuned transformer-based text-to-SQL models) to generate a structured query that accurately reflects the user’s intent, as expressed in the original natural language query (as further described herein).

The semantic model provides the necessary context for mapping abstract user inputs to specific schema elements, column names, filters, groupings, and other SQL clauses. For example, a user query such as “What was the churn rate last quarter for premium customers?” may be translated into a SQL statement that includes the appropriate joins, date filters, and conditional expressions based on metadata in the target semantic model.

After the SQL statement is generated, the system executes the query against the underlying data source, which may be a relational database, cloud data warehouse, or a federated data engine. The system may apply additional runtime features such as access control enforcement, result caching, or execution monitoring to ensure performance and compliance. The result of this execution is returned to the user in a structured or natural language form, completing the end-to-end pipeline from natural language query input to answer output.

This architecture—where the pruned model is used for selection but the full model is used for execution—ensures both efficiency in model routing and accuracy and completeness in final query execution. It allows the system to scale to large numbers of models without compromising the fidelity of query results.

Although semantic models are described herein to support the translation of natural language queries into structured query language (SQL), it is appreciated that the semantic models can apply to other use cases beyond SQL generation. In certain implementations, a pruned semantic model—consisting of the most relevant columns and verified queries selected in response to a user query—may be provided to downstream components to optimize performance. For instance, supplying a pruned version of the semantic model can reduce processing latency and token usage, particularly in systems that rely on large language models for interpretation, ranking, or reasoning.

In some embodiments, at least some of the operations described in blocks 306 through 310—such as pruning, retrieval, and semantic model selection—may be performed in real time after receipt of the natural language query. In this configuration, the system dynamically generates embeddings for the natural language query and all candidate semantic models at runtime, performs pruning of the semantic models based on computed relevance scores, retrieves the most relevant models, and performs LLM-based selection. This approach ensures that all decisions are made with up-to-date information and accommodates dynamic datasets, new columns, or changing model configurations. It is particularly well-suited for use cases where model definitions are frequently updated or where query-specific context is crucial.

In alternative embodiments, one or more of these steps—such as the embedding generation used for pruning and retrieval—may be performed in advance of query receipt. For example, the system may precompute embeddings for column descriptions, verified queries, or entire semantic model representations.

These embeddings can be stored as persistent objects in a data store, such as embedding vectors saved in a relational table or indexable structure within a cloud data warehouse. When a natural language query is received, the system only needs to compute an embedding for the query itself, and can then perform vector similarity comparisons between the query embedding and the precomputed model embeddings to identify the most relevant semantic models.

This precomputed approach significantly reduces real-time latency, as the system avoids recomputation of expensive embedding operations at query time.

Instead, the system can directly use these stored embeddings to identify a small set of top-ranked pruned semantic models and proceed immediately to large language model (LLM) selection of the best model for execution. This enables a highly scalable architecture, especially when dealing with large catalogs of semantic models or real-time traffic.

Moreover, the same embedding and retrieval infrastructure may be extended to support unstructured data sources, such as documents, emails, support tickets, or knowledge bases. The system may precompute embeddings for paragraphs, passages, or document metadata and store them in searchable vector indices.

At query time, the same query embedding can be used to identify relevant unstructured content using similarity-based retrieval, and the results can then be merged or handled in parallel with structured model routing. This unified architecture enables seamless semantic search and query routing across both structured and unstructured data, leveraging a shared embedding and retrieval infrastructure.

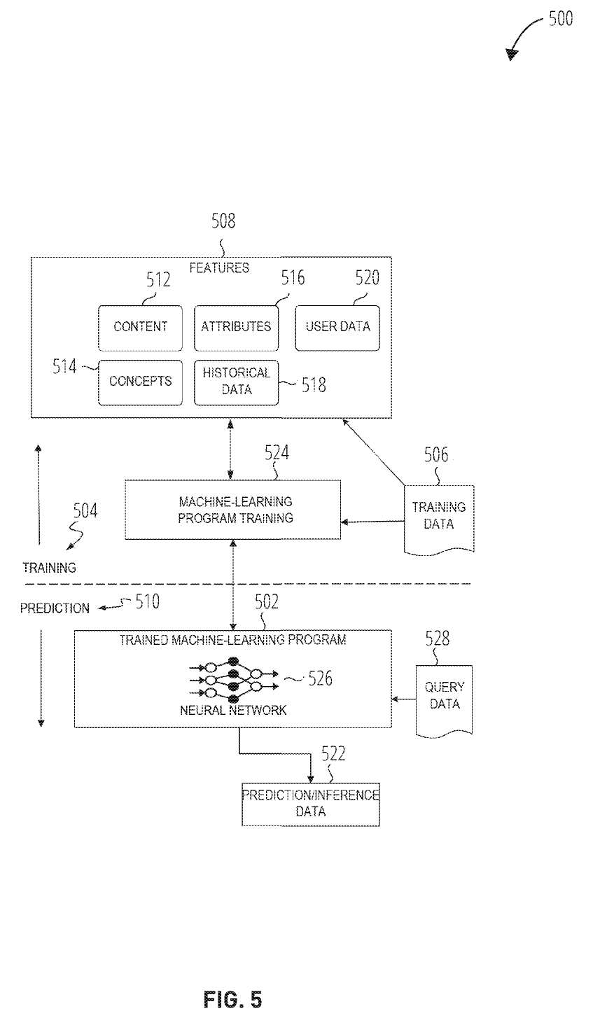

FIG. 5 illustrates n example of training and use of a machine-learning program, according to some examples. In particular, FIG. 5 illustrates further details of two example phases, namely a training phase 504 (e.g., part of the model selection and training 606) and a prediction phase 510 (part of prediction 610). Prior to the training phase 504, feature engineering 604 is used to identify features 508. This may include identifying informative, discriminating, and independent features for effectively operating the trained machine-learning program 502 in pattern recognition, classification, and regression. In some examples, the training data 506 includes labeled data, known for pre-identified features 508 and one or more outcomes. Each of the features 508 may be a variable or attribute, such as an individual measurable property of a process, article, system, or phenomenon represented by a data set (e.g., the training data 506). Features 508 may also be of different types, such as numeric features, strings, and graphs, and may include one or more of content 512, concepts 514, attributes 516, historical data 518, and/or user data 520, merely for example.

In training phase 504, the machine-learning pipeline 500 uses the training data 506 to find correlations among the features 508 that affect a predicted outcome or prediction/inference data 522.

With the training data 506 and the identified features 508, the trained machine-learning program 502 is trained during the training phase 504 during machine-learning program training 524. The machine-learning program training 524 appraises values of the features 508 as they correlate to the training data 506. The result of the training is the trained machine-learning program 502 (e.g., a trained or learned model).

Further, the training phase 504 may involve machine learning, in which the training data 506 is structured (e.g., labeled during preprocessing operations). The trained machine-learning program 502 implements a neural network 526 capable of performing, for example, classification and clustering operations. In other examples, the training phase 504 may involve deep learning, in which the training data 506 is unstructured, and the trained machine-learning program 502 implements a deep neural network 526 that can perform both feature extraction and classification/clustering operations.

In some examples, a neural network 526 may be generated during the training phase 504 and implemented within the trained machine-learning program 502. The neural network 526 includes a hierarchical (e.g., layered) organization of neurons, with each layer consisting of multiple neurons or nodes. Neurons in the input layer receive the input data, while neurons in the output layer produce the final output of the network. Between the input and output layers, there may be one or more hidden layers, each consisting of multiple neurons.

Each neuron in the neural network 526 operationally computes a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, affecting their performance on different tasks. The layered organization of neurons and the use of activation functions and weights enable neural networks to model complex relationships between inputs and outputs, and to generalize to new inputs that were not seen during training.

In some examples, the neural network 526 may also be one of several different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 504, a validation phase may be performed on a separate dataset known as the validation dataset. The validation dataset is used to tune the hyperparameters of a model, such as the learning rate and the regularization parameter. The hyperparameters are adjusted to improve the model's performance on the validation dataset.

Once a model is fully trained and validated, in a testing phase, the model may be tested on a new dataset. The testing dataset is used to evaluate the model's performance and ensure that the model has not overfitted the training data.

In prediction phase 510, the trained machine-learning program 502 uses the features 508 for analyzing query data 528 to generate inferences, outcomes, or predictions, as examples of a prediction/inference data 522. For example, during prediction phase 510, the trained machine-learning program 502 generates an output. Query data 528 is provided as an input to the trained machine-learning program 502, and the trained machine-learning program 502 generates the prediction/inference data 522 as output, responsive to receipt of the query data 528.

In some examples, the trained machine-learning program 502 may be a generative AI model. Generative AI is a term that may refer to any type of artificial intelligence that can create new content from training data 506. For example, generative AI can produce text, images, video, audio, code, or synthetic data similar to the original data but not identical.

Some of the techniques that may be used in generative AI are: Convolutional Neural Networks, Recurrent Neural Networks, generative adversarial networks, variational autoencoders, transformer models, and the like.

For example, Convolutional Neural Networks (CNNs) can be used for image recognition and computer vision tasks. CNNs may, for example, be designed to extract features from images by using filters or kernels that scan the input image and highlight important patterns. Recurrent Neural Networks (RNNs) can be used for processing sequential data, such as speech, text, and time series data, for example. RNNs employ feedback loops that allow them to capture temporal dependencies and remember past inputs. Generative adversarial networks (GANs) can include two neural networks: a generator and a discriminator. The generator network attempts to create realistic content that can “fool” the discriminator network, while the discriminator network attempts to distinguish between real and fake content. The generator and discriminator networks compete with each other and improve over time. Variational autoencoders (VAEs) can encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies. Transformer models can use attention mechanisms to learn the relationships between different parts of input data (such as words or pixels) and generate output data based on these relationships. Transformer models can handle sequential data, such as text or speech, as well as non-sequential data, such as images or code. In generative AI examples, the output prediction/inference data 522 can include predictions, translations, summaries, media content, and the like, or some combination thereof.

In some example embodiments, computer-readable files come in several varieties, including unstructured files, semi-structured files, and structured files. These terms may mean different things to different people. Examples of structured files include Variant Call Format (VCF) files, Keithley Data File (KDF) files, Hierarchical Data Format version 5 (HDF5) files, and the like. As known to those of skill in the relevant arts, VCF files are often used in the bioinformatics field for storing, e.g., gene-sequence variations, KDF files are often used in the semiconductor industry for storing, e.g., semiconductor-testing data, and HDF5 files are often used in industries such as the aeronautics industry, in that case for storing data such as aircraft-emissions data.

As used herein, examples of unstructured files include image files, video files, PDFs, audio files, and the like; examples of semi-structured files include JavaScript Object Notation (JSON) files, eXtensible Markup Language (XML) files, and the like. Numerous other example unstructured-file types, semi-structured-file types, and structured-file types, as well as example uses thereof, could certainly be listed here as well and will be familiar to those of skill in the relevant arts. Different people of skill in the relevant arts may classify types of files differently among these categories and may use one or more different categories instead of or in addition to one or more of these.

Data platforms are widely used for data storage and data access in computing and communication contexts. Concerning architecture, a data platform could be an on-premises data platform, a network-based data platform (e.g., a cloud-based data platform), a combination of the two, and/or include another type of architecture. Concerning the type of data processing, a data platform could implement online analytical processing (OLAP), online transactional processing (OLTP), a combination of the two, and/or another type of data processing. Moreover, a data platform could be or include a relational database management system (RDBMS) and/or one or more other types of database management systems.

In a typical implementation, a cloud data platform 102 can include one or more databases that are respectively maintained in association with any number of customer accounts (e.g., accounts of one or more data providers), as well as one or more databases associated with a system account (e.g., an administrative account) of the data platform, one or more other databases used for administrative purposes, and/or one or more other databases that are maintained in association with one or more other organizations and/or for any other purposes. A cloud data platform 102 may also store metadata (e.g., account object metadata) in association with the data platform in general and in association with, for example, particular databases and/or particular customer accounts as well. Users and/or executing processes that are associated with a given customer account may, via one or more types of clients, be able to cause data to be ingested into the database, and may also be able to manipulate the data, add additional data, remove data, run queries against the data, generate views of the data, and so forth. As used herein, the terms “account object metadata” and “account object” are used interchangeably.

In an implementation of a cloud data platform 102, a given database (e.g., a database maintained for a customer account) may reside as an object within, e.g., a customer account, which may also include one or more other objects (e.g., users, roles, grants, shares, warehouses, resource monitors, integrations, network policies, and/or the like). Furthermore, a given object such as a database may itself contain one or more objects such as schemas, tables, materialized views, and/or the like. A given table may be organized as a collection of records (e.g., rows) so that each includes a plurality of attributes (e.g., columns). In some implementations, database data is physically stored across multiple storage units, which may be referred to as files, blocks, partitions, micro-partitions, and/or by one or more other names. In many cases, a database on a data platform serves as a backend for one or more applications that are executing on one or more application servers.

In the present disclosure, physical units of data that are stored in a cloud data platform—and that make up the content of, e.g., database tables in customer accounts (e.g., customer users)—are referred to as micro-partitions. In different implementations, a cloud data platform can store metadata in micro-partitions as well. The term “micro-partitions” is distinguished in this disclosure from the term “files,” which, as used herein, refers to data units such as image files (e.g., Joint Photographic Experts Group (JPEG) files, Portable Network Graphics (PNG) files, etc.), video files (e.g., Moving Picture Experts Group (MPEG) files, MPEG-4 (MP4) files, Advanced Video Coding High Definition (AVCHD) files, etc.), Portable Document Format (PDF) files, documents that are formatted to be compatible with one or more word-processing applications, documents that are formatted to be compatible with one or more spreadsheet applications, and/or the like. If stored internal to the cloud data platform, a given file is referred to herein as an “internal file” and may be stored in (or at, or on, etc.) what is referred to herein as an “internal storage location.” If stored external to the cloud data platform, a given file is referred to herein as an “external file” and is referred to as being stored in (or at, or on, etc.) what is referred to herein as an “external storage location.”

While example embodiments of the present disclosure reference commands in the standardized syntax of the programming language Structured Query Language (SQL), it will be understood by one having ordinary skill in the art that the present disclosure can similarly apply to other programming languages associated with communicating and retrieving data from a database.

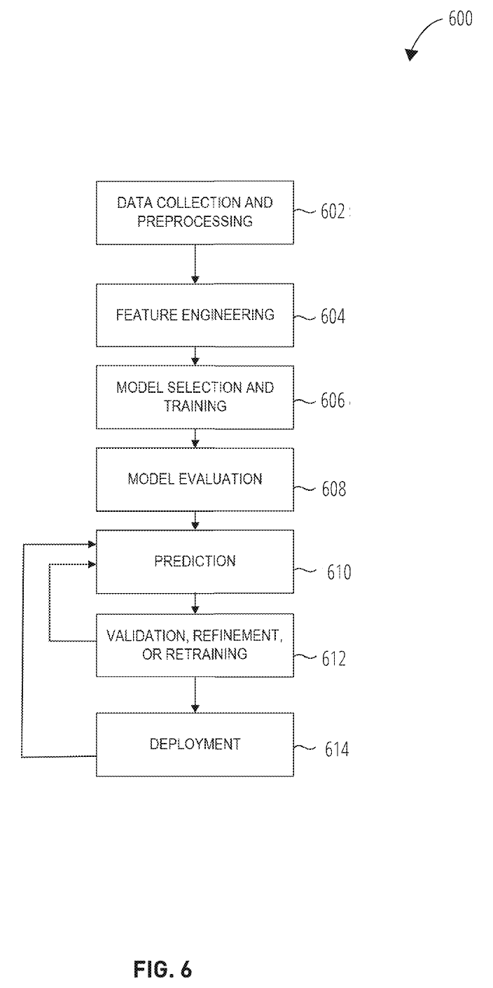

FIG. 6 depicts an example machine-learning pipeline 600 and FIG. 6 illustrates training and use of a machine-learning program (e.g., model) 500. Specifically, FIG. 6 is a flowchart depicting a machine-learning pipeline 600, according to some examples. The machine-learning pipeline 600 can be used to generate a trained model, for example the trained machine-learning program 502 of FIG. 5, to perform operations associated with searches and query responses.

Broadly, machine learning may involve using computer algorithms to automatically learn patterns and relationships in data, potentially without the need for explicit programming. Machine learning algorithms can be divided into three main categories: supervised learning, unsupervised learning, self-supervised, and reinforcement learning.

For example, supervised learning involves training a model using labeled data to predict an output for new, unseen inputs. Examples of supervised learning algorithms include linear regression, decision trees, and neural networks. Unsupervised learning involves training a model on unlabeled data to find hidden patterns and relationships in the data. Examples of unsupervised learning algorithms include clustering, principal component analysis, and generative models like autoencoders. Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is another supervised learning algorithm used for classification tasks. Naïve Bayes is based on Bayes’ theorem and assumes that the predictor variables are independent of each other. Random Forest is another type of supervised learning algorithm used for classification, regression, and other tasks. Random Forest builds a collection of decision trees and combines their outputs to make predictions.

Further examples include neural networks, which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting may be used in various machine learning applications.

Two example types of problems in machine learning are classification problems and regression problems. Classification problems, also referred to as categorization problems, aim at classifying items into one of several category values (e.g., is this object an apple or an orange?). Regression algorithms aim at quantifying some items (for example, by providing a value that is a real number).

Turning to the training phases 504 as described and depicted in connection with FIG. 6, generating a trained machine-learning program 502 may include multiple phases that form part of the machine-learning pipeline 600, including for example the following phases illustrated in FIG. 6: data collection and preprocessing 602, feature engineering 604, model selection and training 606, model evaluation 608, prediction 610, validation, refinement, or retraining 612, and deployment 614, or a combination thereof.

For example, data collection and preprocessing 602 can include a phase for acquiring and cleaning data to ensure that it is suitable for use in the machine learning model. This phase may also include removing duplicates, handling missing values, and converting data into a suitable format. Feature engineering 604 can include a phase for selecting and transforming the training data 506 to create features that are useful for predicting the target variable. Feature engineering may include (1) receiving features 508 (e.g., as structured or labeled data in supervised learning) and/or (2) identifying features 508 (e.g., unstructured, or unlabeled data for unsupervised learning) in training data 506. Model selection and training 606 can include a phase for selecting an appropriate machine learning algorithm and training it on the preprocessed data. This phase may further involve splitting the data into training and testing sets, using cross-validation to evaluate the model, and tuning hyperparameters to improve performance.

In additional examples, model evaluation 608 can include a phase for evaluating the performance of a trained model (e.g., the trained machine-learning program 502) on a separate testing dataset. This phase can help determine if the model is overfitting or underfitting and determine whether the model is suitable for deployment. Prediction 610 can include a phase for using a trained model (e.g., trained machine-learning program 502) to generate predictions on new, unseen data. Validation, refinement or retraining 612 can include a phase for updating a model based on feedback generated from the prediction phase, such as new data or user feedback. Deployment 614 can include a phase for integrating the trained model (e.g., the trained machine-learning program 502) into a more extensive system or application, such as a web service, mobile app, or IoT device. This phase can involve setting up APIs, building a user interface, and ensuring that the model is scalable and can handle large volumes of data.

In view of the disclosure above, various examples are set forth below. It should be noted that one or more features of an example, taken in isolation or combination, should be considered within the disclosure of this application.

Example 1 is a computer system comprising: at least one hardware processor; and at least one memory storing instructions that cause the at least one hardware processor to perform operations comprising: receiving a natural language query; accessing a plurality of semantic models, each semantic model comprising a plurality of columns, wherein each column comprises a corresponding description associated with data stored in the individual column; generating a pruned semantic model for each semantic model by selecting a subset of the columns based on the natural language query and the descriptions of the columns for the individual semantic model; determining a set of candidate semantic models by determining a similarity metric between the natural language query and the pruned semantic models; selecting a target semantic model from among the candidate semantic models using a large language model (LLM) based on the natural language query and the candidate semantic models; and executing the natural language query using the target semantic model.

In Example 2, the subject matter of Example 1 includes, wherein accessing the plurality of semantic models comprises receiving a list of semantic models specified by a user as part of or in association with the natural language query.

In Example 3, the subject matter of Examples 1–2 includes, wherein the description associated with each column comprises a natural language description of the data stored in the column, wherein generating the pruned semantic model comprises determining a similarity factor between the natural language description with the natural language query.

In Example 4, the subject matter of Examples 1–3 includes, wherein generating the pruned semantic model comprises: generating a first vector-based embedding of the natural language query; generating a second vector-based embedding of each column description in the semantic model; and comparing the first vector-based embedding with individual second vector-based embeddings to identify the subset of columns.

In Example 5, the subject matter of Example 4 includes, wherein comparing the first vector-based embedding with individual second vector-based embeddings comprises determining a similarity score based on a cosine similarity between the first vector-based embedding with individual second vector-based embeddings.

In Example 6, the subject matter of Examples 1–5 includes, wherein each semantic model corresponds to a database or data source and comprises metadata defining a schema for querying the data source.

In Example 7, the subject matter of Examples 1–6 includes, wherein each semantic model comprises a plurality of verified queries comprising example natural language queries associated with the semantic model, wherein generating the pruned semantic model further comprises selecting a subset of the verified queries based on a similarity metric between the natural language query and each verified query.

In Example 8, the subject matter of Example 7 includes, wherein the system bypasses generation of a pruned semantic model for a semantic model having fewer than a predefined number of verified queries.

In Example 9, the subject matter of Examples 1–8 includes, wherein the system bypasses generation of a pruned semantic model for a semantic model having fewer than a predefined number of columns.

In Example 10, the subject matter of Examples 1–9 includes, wherein determining the similarity metric between the natural language query and each of the pruned semantic models comprises generating an embedding of the natural language query and an embedding of each pruned semantic model.

In Example 11, the subject matter of Example 10 includes, wherein the embedding of a pruned semantic model is based on an aggregation of embeddings of one or more selected column descriptions or verified queries within the pruned semantic model.

In Example 12, the subject matter of Examples 10–11 includes, wherein the similarity metric is computed as a cosine similarity between the embedding of the natural language query and the embedding of each pruned semantic model.

In Example 13, the subject matter of Examples 1–12 includes, wherein selecting the target semantic model comprises providing the natural language query and one or more candidate semantic models as input to LLM configured to evaluate semantic relevance.

In Example 14, the subject matter of Examples 1–13 includes, wherein executing the natural language query comprises generating a structured query in a query language based on the natural language query and the target semantic model.

In Example 15, the subject matter of Example 14 includes, wherein generating the structured query is based on a full version of the target semantic model, comprising columns and metadata not included in the pruned semantic model.

In Example 16, the subject matter of Examples 14–15 includes, wherein generating the structured query comprises applying a text-to-SQL translation model that maps the natural language query to a SQL statement based on schema information in the target semantic model.

Example 17 is a method performed by at least one hardware processor, the method comprising: receiving a natural language query; accessing a plurality of semantic models, each semantic model comprising a plurality of columns, wherein each column comprises a corresponding description associated with data stored in the individual column; generating a pruned semantic model for each semantic model by selecting a subset of the columns based on the natural language query and the descriptions of the columns for the individual semantic model; determining a set of candidate semantic models by determining a similarity metric between the natural language query and the pruned semantic models; selecting a target semantic model from among the candidate semantic models using a large language model (LLM) based on the natural language query and the candidate semantic models; and executing the natural language query using the target semantic model.

Example 18 is computer-storage media comprising instructions that, when executed by one or more processors of a machine, configure the machine to perform operations comprising: receiving a natural language query; accessing a plurality of semantic models, each semantic model comprising a plurality of columns, wherein each column comprises a corresponding description associated with data stored in the individual column; generating a pruned semantic model for each semantic model by selecting a subset of the columns based on the natural language query and the descriptions of the columns for the individual semantic model; determining a set of candidate semantic models by determining a similarity metric between the natural language query and the pruned semantic models; selecting a target semantic model from among the candidate semantic models using a large language model (LLM) based on the natural language query and the candidate semantic models; and executing the natural language query using the target semantic model.

Example 19 is at least one machine-readable medium including instructions that, when executed by processing circuitry, cause the processing circuitry to perform operations to implement any of Examples 1–18.

Example 20 is an apparatus comprising means to implement any of Examples 1–18.

Example 21 is a system to implement any of Examples 1–18.

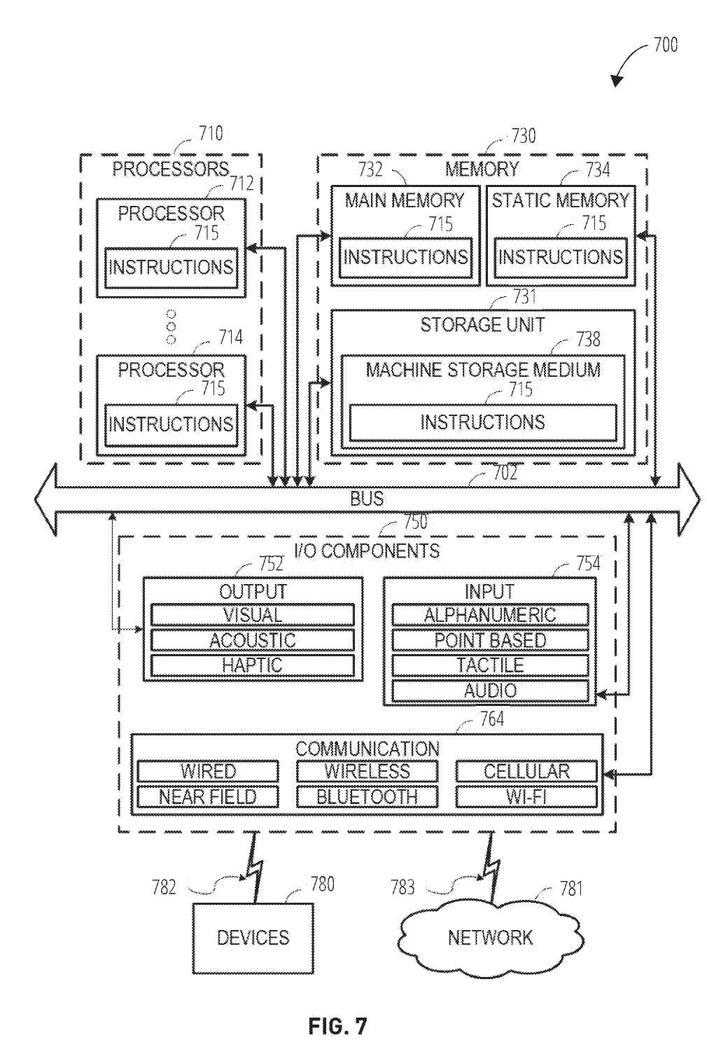

Example 22 is a method to implement any of Examples 1–18. FIG. 7 illustrates a diagrammatic representation of a machine 700 in the form of a computer system within which a set of instructions may be executed for causing the machine 700 to perform any one or more of the methodologies discussed herein, according to an example embodiment. Specifically, FIG. 7 shows a diagrammatic representation of the machine 700 in the example form of a computer system, within which instructions 715 (e.g., software, a program, an application, an applet, an app, or other executable code), for causing the machine 700 to perform any one or more of the methodologies discussed herein, may be executed. For example, the instructions 715 may cause the machine 700 to implement portions of the data flows described herein. In this way, the instructions 715 transform a general, non-programmed machine into a particular machine 700 (e.g., the client device 112 of FIG. 1, the compute service manager 108 of FIG. 1, the execution platform 110 of FIG. 1) that is specially configured to carry out any one of the described and illustrated functions in the manner described herein.

In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 715, sequentially or otherwise, that specify actions to be taken by the machine 700. Further, while only a single machine 700 is illustrated, the term “machine” shall also be taken to include a collection of machines 700 that individually or jointly execute the instructions 715 to perform any one or more of the methodologies discussed herein.

The machine 700 includes processors 710 (such as processor 712 and processor 714), memory 730, and input/output (I/O) I/O components 750 (including output components 752 and input components 754) configured to communicate with each other such as via a bus 702. In an example embodiment, the processors 710 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 712 and a processor 714 that may execute the instructions 715. The term “processor” is intended to include multi-core processors 710 that may comprise two or more independent processors (sometimes referred to as “cores”) that may execute instructions 715 contemporaneously. Although FIG. 7 shows multiple processors 710, the machine 700 may include a single processor with a single core, a single processor with multiple cores (e.g., a multi-core processor), multiple processors with a single core, multiple processors with multiple cores, or any combination thereof.

The memory 730 may include a main memory 732, a static memory 734, and a storage unit 731, all accessible to the processors 710 such as via the bus 702. The main memory 732, the static memory 734, and the storage unit 731 comprise a machine storage medium 738 that may store the instructions 715 embodying any one or more of the methodologies or functions described herein. The instructions 715 may also reside, completely or partially, within the main memory 732, within the static memory 734, within the storage unit 731, within at least one of the processors 710 (e.g., within the processor’s cache memory), or any suitable combination thereof, during execution thereof by the machine 700.

The I/O components 750 include components to receive input, provide output, produce output, transmit information, exchange information, capture measurements, and so on. The specific I/O components 750 that are included in a particular machine 700 will depend on the type of machine. For example, portable machines, such as mobile phones, will likely include a touch input device or other such input mechanisms, while a headless server machine will likely not include such a touch input device. It will be appreciated that the I/O components 750 may include many other components that are not shown in FIG. 7. The I/O components 750 are grouped according to functionality merely for simplifying the following discussion and the grouping is in no way limiting. In various example embodiments, the I/O components 750 may include output components 752 and input components 754. The output components 752 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 754 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 750 may include communication components 764 operable to couple the machine 700 to a network 781 via a coupler 783 or to devices 780 via a coupling 782. For example, the communication components 764 may include a network interface component or another suitable device to interface with the network 781. In further examples, the communication components 764 may include wired communication components, wireless communication components, cellular communication components, and other communication components to provide communication via other modalities. The devices 780 may be another machine or any of a wide variety of peripheral devices (e.g., a peripheral device coupled via a universal serial bus (USB)). For example, as noted above, the machine 700 may correspond to any one of the client device 112, the compute service manager 108, and the execution platform 110, and may include any other of these systems and devices.

The various memories (e.g., 730, 732, 734, and/or memory of the processor(s) 710 and/or the storage unit 731) may store one or more sets of instructions 715 and data structures (e.g., software), embodying or utilized by any one or more of the methodologies or functions described herein. These instructions 715, when executed by the processor(s) 710, cause various operations to implement the disclosed embodiments.

Another general aspect is for a system that includes a memory comprising instructions and one or more computer processors or one or more hardware processors. The instructions, when executed by the one or more computer processors, cause the one or more computer processors to perform operations. In yet another general aspect, a tangible machine-readable storage medium (e.g., a non-transitory storage medium) includes instructions that, when executed by a machine, cause the machine to perform operations.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, (e.g., erasable programmable read-only memory (EPROM), electrically erasable programmable read-only memory (EEPROM), field-programmable gate arrays (FPGAs), and flash memory devices); magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 781 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 781 or a portion of the network 781 may include a wireless or cellular network, and the coupling 782 may be a Code Division Multiple Access (CDMA) connection, a Global System for Mobile communications (GSM) connection, or another type of cellular or wireless coupling. In this example, the coupling 782 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 715 may be transmitted or received over the network 781 using a transmission medium via a network interface device (e.g., a network interface component included in the communication components 764) and utilizing any one of a number of well-known transfer protocols (e.g., hypertext transfer protocol (HTTP)). Similarly, the instructions 715 may be transmitted or received using a transmission medium via the coupling 782 (e.g., a peer-to-peer coupling) to the devices 780. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 715 for execution by the machine 700, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor implemented. For example, at least some of the operations of the methods described herein may be performed by one or more processors. The performance of certain of the operations may be distributed among the one or more processors, not only residing within a single machine, but also deployed across a number of machines. In some example embodiments, the processor or processors may be located in a single location (e.g., within a home environment, an office environment, or a server farm), while in other embodiments the processors may be distributed across a number of locations.

Although the embodiments of the present disclosure have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

Also, in the above Detailed Description, various features can be grouped together to streamline the disclosure. However, the claims cannot set forth every feature disclosed herein, as embodiments can feature a subset of said features. Further, embodiments can include fewer features than those disclosed in a particular example. Thus, the following claims are hereby incorporated into the Detailed Description, with each claim standing on its own as a separate embodiment. The scope of the embodiments disclosed herein is to be determined with reference to the appended claims, along with the full scope of equivalents to which such claims are entitled.

Unless the context clearly requires otherwise, throughout the description and the claims, the words “comprise,” “comprising,” and the like are to be construed in an inclusive sense, as opposed to an exclusive or exhaustive sense, i.e., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

The various features, steps, and processes described herein may be used independently of one another, or may be combined in various ways. All possible combinations and subcombinations are intended to fall within the scope of this disclosure. In addition, certain method or process blocks may be omitted in some implementations.

What is claimed is:

1. A computer system comprising:
at least one hardware processor; and
at least one memory storing instructions that cause the at least one hardware processor to perform operations comprising:
receiving a natural language query;
accessing a plurality of semantic models, each semantic model comprising a plurality of columns, wherein each column comprises a corresponding description associated with data stored in the individual column;
generating a pruned semantic model for each semantic model by selecting a subset of the columns based on the natural language query and the descriptions of the columns for the individual semantic model;
determining a set of candidate semantic models by determining a similarity metric between the natural language query and the pruned semantic models;
selecting a target semantic model from among the candidate semantic models using a large language model (LLM) based on the natural language query and the candidate semantic models; and
executing the natural language query using the target semantic model.

2. The computer system of claim 1, wherein accessing the plurality of semantic models comprises receiving a list of semantic models specified by a user as part of or in association with the natural language query.

3. The computer system of claim 1, wherein the description associated with each column comprises a natural language description of the data stored in the column, wherein generating the pruned semantic model comprises determining a similarity factor between the natural language description with the natural language query.

4. The computer system of claim 1, wherein generating the pruned semantic model comprises:
generating a first vector-based embedding of the natural language query;
generating a second vector-based embedding of each column description in the semantic model; and
comparing the first vector-based embedding with individual second vector-based embeddings to identify the subset of columns.

5. The computer system of claim 4, wherein comparing the first vector-based embedding with individual second vector-based embeddings comprises determining a similarity score based on a cosine similarity between the first vector-based embedding with individual second vector-based embeddings.

6. The computer system of claim 1, wherein each semantic model corresponds to a database or data source and comprises metadata defining a schema for querying the data source.

7. The computer system of claim 1, wherein each semantic model comprises a plurality of verified queries comprising example natural language queries associated with the semantic model, wherein generating the pruned semantic model further comprises selecting a subset of the verified queries based on a similarity metric between the natural language query and each verified query.

8. The computer system of claim 7, wherein the system bypasses generation of a pruned semantic model for a semantic model having fewer than a predefined number of verified queries.

9. The computer system of claim 1, wherein the system bypasses generation of a pruned semantic model for a semantic model having fewer than a predefined number of columns.

10. The computer system of claim 1, wherein determining the similarity metric between the natural language query and each of the pruned semantic models comprises generating an embedding of the natural language query and an embedding of each pruned semantic model.

11. The computer system of claim 10, wherein the embedding of a pruned semantic model is based on an aggregation of embeddings of one or more selected column descriptions or verified queries within the pruned semantic model.

12. The computer system of claim 10, wherein the similarity metric is computed as a cosine similarity between the embedding of the natural language query and the embedding of each pruned semantic model.

13. The computer system of claim 1, wherein selecting the target semantic model comprises providing the natural language query and one or more candidate semantic models as input to LLM configured to evaluate semantic relevance.

14. The computer system of claim 1, wherein executing the natural language query comprises generating a structured query in a query language based on the natural language query and the target semantic model.

15. The computer system of claim 14, wherein generating the structured query is based on a full version of the target semantic model, comprising columns and metadata not included in the pruned semantic model.

16. The computer system of claim 14, wherein generating the structured query comprises applying a text-to-SQL translation model that maps the natural language query to a SQL statement based on schema information in the target semantic model.

17. A method performed by at least one hardware processor, the method comprising:
receiving a natural language query;
accessing a plurality of semantic models, each semantic model comprising a plurality of columns, wherein each column comprises a corresponding description associated with data stored in the individual column;
generating a pruned semantic model for each semantic model by selecting a subset of the columns based on the natural language query and the descriptions of the columns for the individual semantic model;
determining a set of candidate semantic models by determining a similarity metric between the natural language query and the pruned semantic models;
selecting a target semantic model from among the candidate semantic models using a large language model (LLM) based on the natural language query and the candidate semantic models; and
executing the natural language query using the target semantic model.

18. Computer-storage media comprising instructions that, when executed by one or more processors of a machine, configure the machine to perform operations comprising:
receiving a natural language query;
accessing a plurality of semantic models, each semantic model comprising a plurality of columns, wherein each column comprises a corresponding description associated with data stored in the individual column;
generating a pruned semantic model for each semantic model by selecting a subset of the columns based on the natural language query and the descriptions of the columns for the individual semantic model;
determining a set of candidate semantic models by determining a similarity metric between the natural language query and the pruned semantic models;
selecting a target semantic model from among the candidate semantic models using a large language model (LLM) based on the natural language query and the candidate semantic models; and
executing the natural language query using the target semantic model.
